(19) United States
(12) Patent Application Publication
(10) Pub. No.: US 2013/0203172 A1
(43) Pub. Date: Aug. 8, 2013

(54) SELF-CONTAINED MULTI-REAGENT ASSAY DEVICE

(71) Applicant: Bio-Rad Laboratories, Inc., Hercules, CA (US)

(72) Inventors: Hannah Wex, Saltney (GB); Matthew Pearce, Chester (GB); Richard Hall, Waverton (GB); Jake Hodgson, Flintshire (GB)

(73) Assignee: Bio-Rad Laboratories, Inc., Hercules, CA (US)

(21) Appl. No.: 13/719,828

(22) Filed: Dec. 19, 2012

Related U.S. Application Data
(60) Provisional application No. 61/596,510, filed on Feb. 8, 2012.

(51) Int. Cl. B01L 3/00

(52) U.S. Cl. CPC B01L 3/502
USPC 436/43; 422/554

(57) ABSTRACT

A single closed and compartmentalized vessel is designed to contain all assay reagents necessary to conduct an assay of a liquid sample. The vessel is constructed in parts that are rotatable relative to each other, and processing steps of the assay such as combining, mixing, separating, and measuring are all conducted by either rotating the parts relative to each other or rotating the vessel as a whole, all without opening the receptacle or otherwise exposing the user to any of the liquids or substances within the receptacle.

### CROSS-REFERENCE TO RELATED APPLICATION

This application claims the benefit of U.S. Provisional Patent Application No. 61/596,510, filed Feb. 8, 2012, the contents of which are incorporated herein by reference in their entirety.

### BACKGROUND OF THE INVENTION

1. Field of the Invention

This invention resides in the field of assays of liquid samples, including biological samples, for the detection, and in many cases, the quantification, of analytes.

2. Description of the Prior Art

Assays of biological samples such as blood, serum, plasma, urine, cerebrospinal fluid, and the like for specified analytes typically involve treatment of the samples with a succession of assay reagents and the taking of one or more measurements or detections of the assay medium at specified steps of the assay. Immunological or other binding assays are typical examples of the types of assays performed, and the assay reagents typically include a binding medium and a wash liquid to separate bound from unbound species, plus one or more buffers such as a binding buffer, an elution buffer, and an equilibration buffer. Performance of an assay typically involves pipetting or other liquid transfer methods to combine the sample with the various assay reagents, mixing and agitation of the resulting mixtures, incubation of the sample with the reagents, and the separation of phases, each step being performed for a specified length of time, with a specified amount of each reagent, and at a specified temperature. The risk of error is always present, and the labor, equipment, bench space, and time needed to perform the steps of the assay all contribute to the cost of the assay and limit the speed of the assay and the number of samples that can be processed.

### SUMMARY OF THE INVENTION

Devices and methods have now been developed that allow all assay reagents needed to conduct a given assay to be placed inside a single closed and compartmentalized vessel where the sample and reagents can be manipulated by processing steps such as combining, mixing, separating, and measuring, in accordance with the assay procedure, without opening the receptacle or otherwise exposing the user to any of the liquids or substances within the receptacle. The entire vessel can be prepackaged, as can the portions that contain the assay reagents. In either case, all assay reagents can be sealed inside the packaging so that only the sample need be added to allow the assay procedure to begin. In many cases, the vessel is mounted or otherwise equipped for rotation and some, and often all, of the processing steps are accomplished by simple rotation of the vessel. When an assay requires the use of two or more assay reagents, the reagents are placed in separate, individual compartments within the closed vessel, each compartment being designed to release its contents separately to a sample contact area upon appropriate manipulation of the vessel. Certain vessels within the scope of this invention are constructed in two or more parts or bodies that once joined form a composite body with parts that are being movable relative to each other, for example by rotation. Manipulation of the reagents is then accomplished by rotation of one part relative to the remaining part(s), by rotation of the entire vessel, or by a combination of the two rotations. Such rotation(s) can be combined with gravity flow to achieve transfer of the reagents from one region of the vessel interior to another, and also to achieve agitation and mixing of reaction mixtures within the vessel. Rotation can also be used to break, puncture, or remove seals from individual compartments within the vessel to release the assay reagents individually and at selected times into the sample contact area. Detection of the progress of the assay, or of the assay results, or both, can be achieved by a detection window in the sample contact area in conjunction with detection components that may be external to the vessel.

Also provided herein is a cartridge for retaining two or more liquids which can serve as one part of certain embodiments of the multi-part vessel described in the preceding paragraph. The cartridge, which can be a disposable part (or, as referred to in the biotechnology industry, a “consumable”), is a body with at least one substantially planar surface, and the liquids are retained in individual compartments within the cartridge, each compartment formed by a recess in the planar surface covered by a flexible sheet. The sheet has an exposed tab that can be engaged and pulled by an adjacent part of the vessel when the adjacent part is moved, e.g. rotated, relative to the cartridge, to detach the sheet from the surface and expose the liquid within the recess. In cartridges with two substantially parallel planar surfaces, recesses can reside in both planar surfaces, opening to opposite sides of the cartridge, each recess covered by the flexible sheet with an exposed tab. The tabs will then be engaged by adjacent parts of the vessel on opposite sides of the cartridge, each adjacent part being movable, in many cases rotatable, relative to the cartridge, thereby providing a further degree of flexibility, variability, or independence to the release of the assay reagents. For rotatable parts, the cartridge and adjacent part(s) are most conveniently formed as flat disks mounted for rotation about a common axis of rotation passing through their centers.

An assay performed with the use of an assay device as disclosed herein is conducted by first placing a sample within a test, or sample contact, chamber inside the device. The assay reagents are then released into the test chamber in a sequence prescribed by the assay procedure, which is often specific for a particular analyte, sample, or both, by actuating a releasing mechanism within the device for opening the sealed compartments. During or in conjunction with the opening of the compartments, the device is rotated to cause the assay reagents to pass into the test chamber, which can occur by gravity flow. Once in the test chamber, the reagents will contact and react with the contents of the chamber or otherwise perform a function according to the assay protocol. At one or more points of time during the assay procedure, an optical measurement is taken of the contents of the test chamber or possibly some other part of the device. The assay result is then derived from the measurement(s) according to the analyte to which the assay is directed and the type of result sought, such as the presence or absence of the analyte, the proportion of the analyte relative to the sample as a whole, or the condition of the analyte or of the assay medium.

These and other objects, advantages, features, aspects, and embodiments of the invention will be better understood from the description that follows.

### BRIEF DESCRIPTION OF THE FIGURES

FIG. 1 is an exploded perspective view of one example of an assay device in accordance with the present invention.

FIG. 2 is a perspective view of the assay device of FIG. 1 in assembled form.

FIG. 3 is a plan view of one part of an assay reagent pouch included among the components of the assay device shown in FIG. 1.

FIG. 4 is a plan view of a second part of the assay reagent pouch shown in FIG. 1.

FIG. 5A is a side view of the one of the reservoirs in the pouch of FIGS. 3 and 4 in a sealed condition. FIG. 5B is the same view as FIG. 5A but with the pouch in a partially opened condition.

FIG. 6 is a plan view of the lid portion of the assay device shown in FIG. 1.

FIG. 7 is a plan view of the body portion of the assay device shown in FIG. 1.

FIG. 8 is a plan view of the hub portion of the assay device shown in FIG. 1.

FIG. 9 is a plan view of the cover portion of the assay device shown in FIG. 1.

FIG. 10 is a perspective view of a sample holder for use with the assay device shown in FIG. 1.

FIG. 11A is a perspective view of one side of an assay reagent pouch which is an alternative to the assay reagent pouch shown in FIGS. 1, 3, and 4. FIG. 11B is a perspective view of the other side of the assay reagent pouch of FIG. 11A.

### DETAILED DESCRIPTION OF SELECTED EMBODIMENTS OF THE INVENTION

The terms “fluid sample” and “liquid sample” are used herein to denote samples of either biological or non-biological origin, in the form of liquids and suspensions of solids, semi-solids, or cells in liquid suspending media. Suspended material may include biological cells or other biological structures, as well as globules of liquids or gels, and the samples can be suspensions of cells or other biological structures as well as single-phase or multi-phase liquids. Examples of biological samples are whole blood, serum, plasma, cellular fluids, urine, cerebrospinal fluid, and saliva. Such samples can be drawn from humans or animals, including pets and livestock. Plant extracts can also be used as samples. Samples that are not of biological origin include, for example, waste water, water for industrial and residential uses, and water from naturally occurring or artificially created or maintained bodies of water, such as lakes, rivers, oceans, reservoirs, acquifers, and wells.

The term “assay reagent” is used herein to denote any material other than vessels, containers, channels, and conduits, that is placed in contact with the sample or with components of the sample during the course of the assay, and either chemically reacts with, binds to, or otherwise transforms or modifies the sample or other assay reagents. Examples of assay reagents are chromatographic media, buffers for various purposes, and labels and other substances used in detection or measurement.

The term “openable closure” is used herein to denote any lid, cap, membrane, film, or other physical barrier that prevents the passage of liquid but can be opened fully or partially by such means as unsealing, piercing, tearing, lifting, pulverizing, fracturing, or dissolving.

The terms “detection” and “measurement” are used herein to refer to any means of obtaining information that represents the condition of the assay medium, i.e., the mixture in which the assay reactions occur. Examples of such information are the presence or absence of a particular component, such as the analyte or a group of species including the analyte, the quantity, concentration or proportion of a particular component or group of components, and the physical state of the assay medium or components therein.

The terms “rotation” and “rotatable” and variations thereof are used herein to denote circular movement within a plane about an axis, whether the path of motion describes a full circle or part of a circle.

The term “fluid communication” and variations thereof as used herein in conjunction with two or more regions, compartments, or zones within the assay device, denote the ability of a fluid to flow between the regions, compartments, or zones.

The terms “optical detection” and “optical signal” as used herein refer to means of detection or measurement that entail the use of a beam of light or other electromagnetic radiation, in transmission, reflection, absorption, or emission, including excitation and emissions resulting from excitation. The term “optical detection path” refers to a path of travel of a light beam or other optical detection signal between the substance whose detection is being sought and either the source of the radiation, a detector, or both.

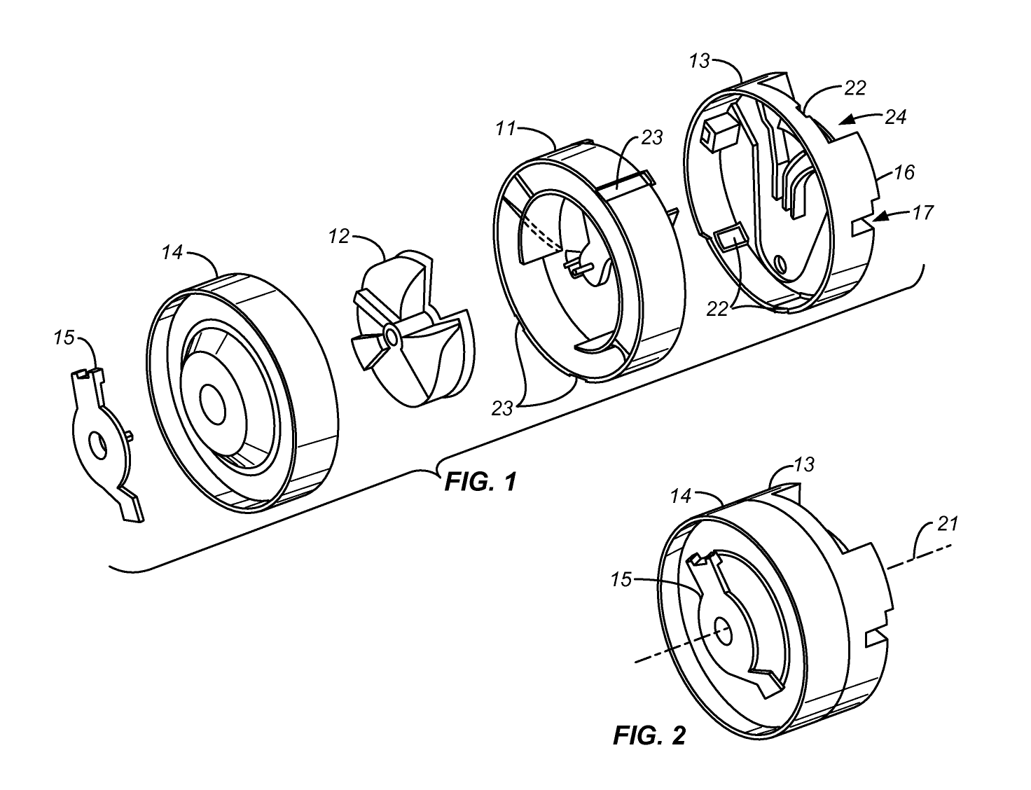

One example of an assay device in accordance with the present invention is depicted in FIG. 1 in an exploded perspective view. The components of the device are individually depicted in successive figures where their structures and features are more readily discernable. As shown in FIG. 1, however, the components include a body 11 that contains flow channels, a mixing area, a sample contact area, and other features to effect contact and manipulation of the sample and assay reagents, an insert or pouch 12 that contains two or more reservoirs (in this case, three reservoirs, as shown and described below) for assay reagents, a cover 13 that fits over one end of the body 11 and contains a slot for insertion of a sample holder (not shown), a lid 14 that fits over the other end of the body 11, and a hub 15 that fits within a recess on one side of the lid 14 and engages the pouch 12 for rotation relative to the body 11. The hub 19 is rotatable by hand or by an automated drive mechanism. The parts when fully assembled appear as shown in FIG. 2, where the body 11 and pouch 12 are not visible since they are fully enclosed by the cover 13 and lid 14. When thus assembled, all parts are aligned along a common axis 21 which serves as an axis of rotation for each of the parts.

Returning to FIG. 1, the cover 13 is constructed with a rim or skirt 16 that contains one or more slots 17 by which the cover can be mounted to an instrument or other supporting structure to prevent rotation of the cover as the hub 15 and pouch 12 are rotated. The slots 17 also serve as contact points to allow rotation of the entire device by transmitting rotation of the cover 13 to the body 11, pouch 12, lid 14, and hub 15. The cover 13 also contains internal features 22 that mate with external features 23 on the body 11 to stabilize the position of the body relative to the cover such that the cover and body will rotate together or remain together in a fixed angular position. The hub 15 can be joined to the lid 14 with a liquid-tight seal, such as by ultrasonic welding. The entire device can thus be rotated as a unit by rotating the cover 13, and the pouch 12 can be rotated independently of the body and the cover by rotating the hub 15. The axis for both such rotations is the common axis 21 (FIG. 2). The cover 13 also contains a separate slot 24 at the periphery of the cover for insertion of the sample holder, which is shown in a succeeding Figure and described below. In use, the device is oriented in a vertical position with the axis 21 vertical and the sample holder slot 24 opening upward, at least at the start of the procedure.

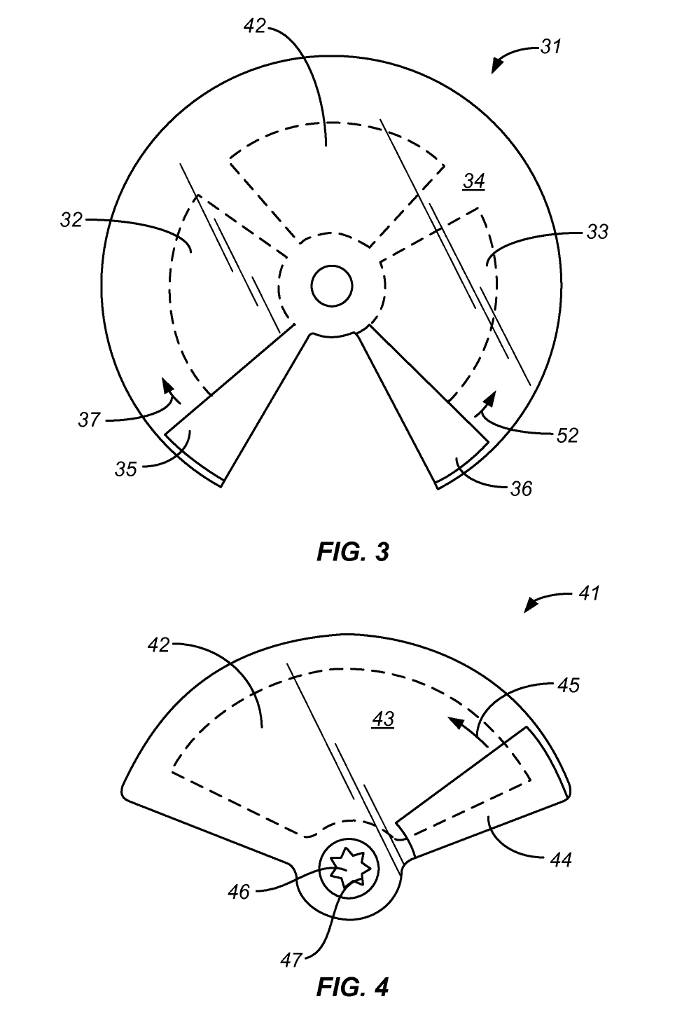

The pouch 12 is constructed in two parts 31, 41 which are shown in FIGS. 3 and 4, respectively. The two parts collectively contain three reservoirs, two of which 32, 33 are in one part 31 (FIG. 3) and the third 42 in the other part (FIG. 4). The first part 31 also serves as a frame to receive the second part 41 in such a manner that when the two parts are combined, two reservoirs 32, 33 open to one side of the pouch and the third 42 opens to the other side. All three reservoirs are outlined in FIG. 3. One side of the first part 31 is covered with aluminum foil 34 or any other covering that serves as the closure mentioned above, to form a seal over the two reservoirs 32, 33 so that assay reagents can be retained in the reservoirs. One side of the second part 41 is likewise covered with foil 43, forming a seal over the third reservoir 42. Thus, the foil covers the reservoirs on two opposing sides of the pouch.

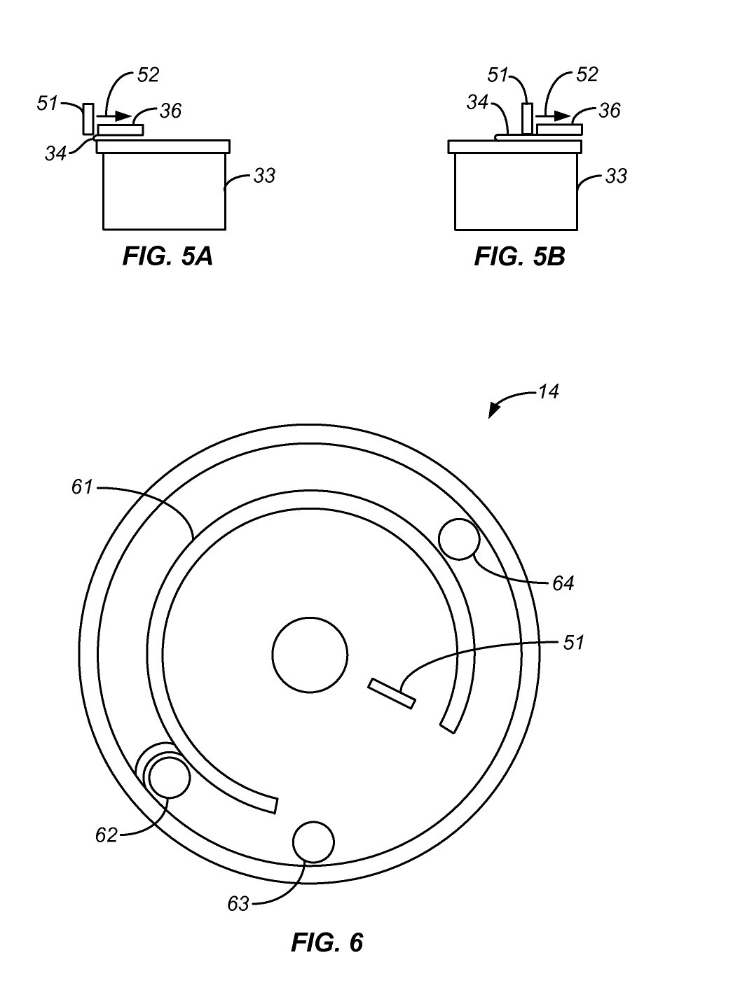

Although aluminum foil is shown as an example, the reservoir coverings can be of a material selected to be punctured, torn, peeled, or otherwise urged to fully or partially remove the coverings and thereby open the reservoirs and release their contents. The foil or other covering can seal the reservoir by way of an adhesive applied along the rim surrounding each reservoir, allowing each reservoir to be opened independently of the others. Mechanisms or structures for the opening function can incorporated in the body 11 and the lid 14, both of which are described below, and can be actuated upon rotation of the pouch relative to either or both of these parts. In the example shown, wedge-shaped blocks 35, 36 (FIGS. 3), and 44 (FIG. 4) are attached to the foils at the radial edges of the foils. These blocks are engaged by implements on the interior surfaces of the body and lid (shown in the Figures discussed below), and thus engaged, the blocks force the seal back when the body and lid are rotated. This action is shown in FIGS. 5A and 5B, which shows the reservoir 33, the wedge-shaped block 36 and the foil covering 34, and an implement in the form of a bar 51. Rotation causes the bar 51 to move relative to the reservoir in the direction shown by the arrow 52, transforming the reservoir from the closed condition shown in FIG. 5A to the open position shown in FIG. 5B. The peel-back direction of each reservoir covering is shown in FIG. 3 by the arrows 37 and 52, and in FIG. 4 by the arrow 45. The wedge-shaped blocks 35, 36, 44, can be replaced by any tab or extension attached to or protruding from each sealing sheet, and the implement can be replaced by any grasping or abutting member as alternatives to the bar 51. Alternatively, a knife edge can protrude from the lid or body to puncture the foil or sealing sheet and expose the contents of the reservoirs. In either case, the selection of individual reservoirs to be opened is made by selecting the direction of rotation of the pouch and rotating the pouch to the appropriate angular position.

While three reservoirs are shown in this embodiment, the number of reservoirs can vary depending on the assay procedure and the number of assay reagents required by the procedure. In certain cases, two reservoirs will be sufficient; in others, three will be needed.

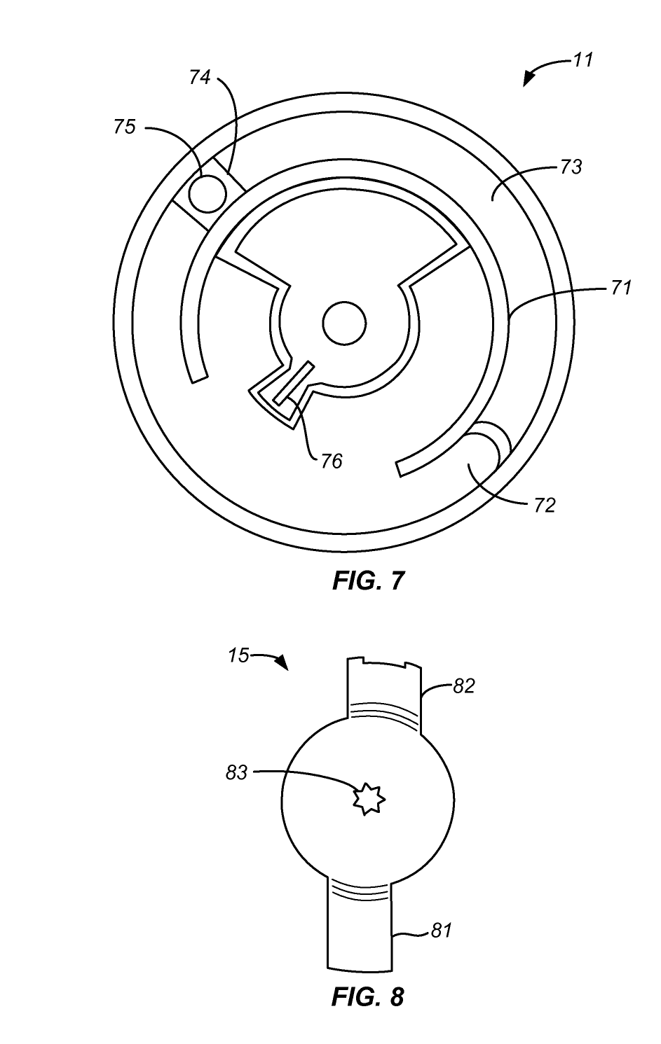

The inner surface of the lid 14, i.e., the surface facing the reagent pouch 12 and the body 11, is shown in FIG. 6. Features of the inner surface of the lid include the bar 51 for opening the reservoir seal, an arc-shaped baffle 61 to contain the assay reagents released from the reservoirs and to direct their flow, and three optical windows 62, 63, 64 at three separate locations angularly spaced from each other, to enable measurements to be taken at three different rotational positions of the device by a stationary optical path.

FIG. 7 depicts the surface of the body 11 that faces the pouch 12 and the lid 14. Features of this surface include an arc-shaped baffle 71 to contain the assay reagents and channel their flow. The sample and assay reagents flow into a mixing, reaction and measurement area 72 where mixing occurs by oscillation of the body 11 about the axis of rotation 21 (FIGS. 1 and 2) and where a binding medium can be formed or accumulated to allow binding reactions to occur. Absorbent material is retained in a holding area 73 to absorb excess liquids passing through the mixing, reaction and measurement area 72. Detections and measurements are also preformed in a separate measurement area 74 with an optical window 75. All such areas are in fluid communication, and thus liquids passing through the mixing, reaction and measurement area 72 can flow into the absorbent material area 73. Liquids that can be retained by the absorbent material include discharged wash liquids, excess portions of the sample, sample components eluted from binding media, and the like. A bar 76 for opening a reservoir seal as described above is molded into the body. The body may also include one or more stops to limit the range of rotation of the pouch.

The surface of the hub 15 that faces the lid 14 is shown in FIG. 8. Tabs 81, 82 on the hub can be grasped by an instrument to rotate the hub, and transmission of the hub rotation to the pouch is achieved by a boss 83 protruding from the inner surface of the hub along the axis of rotation. The boss 83 fits inside an axial aperture 46 in a frame portion of one of the pouch parts 41 (FIG. 4). The boss has a ribbed outer surface that mates with a complementary ribbed inner surface 47 of the interior wall of the aperture. The instrument (not shown) that turns the hub is a conventional laboratory instrument that can be programmed to turn the hub according to a sequence, at specified times and to specified degrees of rotation in specified directions. Construction of such an instrument will be readily apparent to those of skill in the art, and the ways of programming of the instrument for particular assays and samples will also be readily apparent. A hub can also be designed that can be turned by hand.

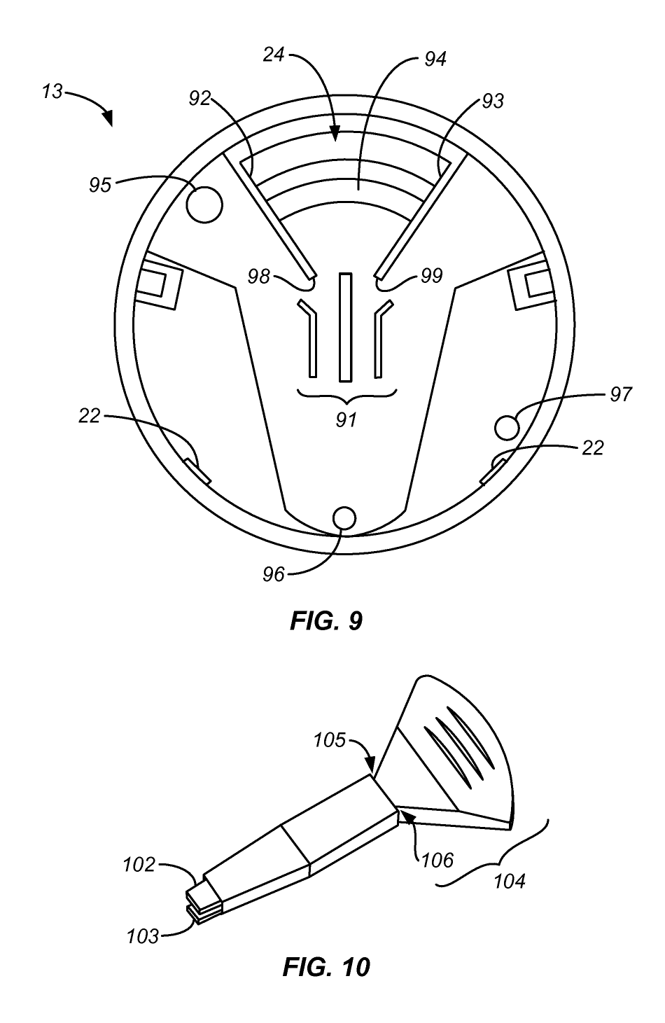

FIG. 9 depicts the inner surface of the cover 13, i.e., the surface facing the body 11. Features included on this inner surface, in addition to those described above in connection with

FIG. 1, are ribs 91 to hold the sample holder in a proper orientation, baffles 92, 93, 94 to guide the insertion of the sample holder and three optical windows 95, 96, 97 to allow detection and/or measurement to be performed at three angles of rotation.

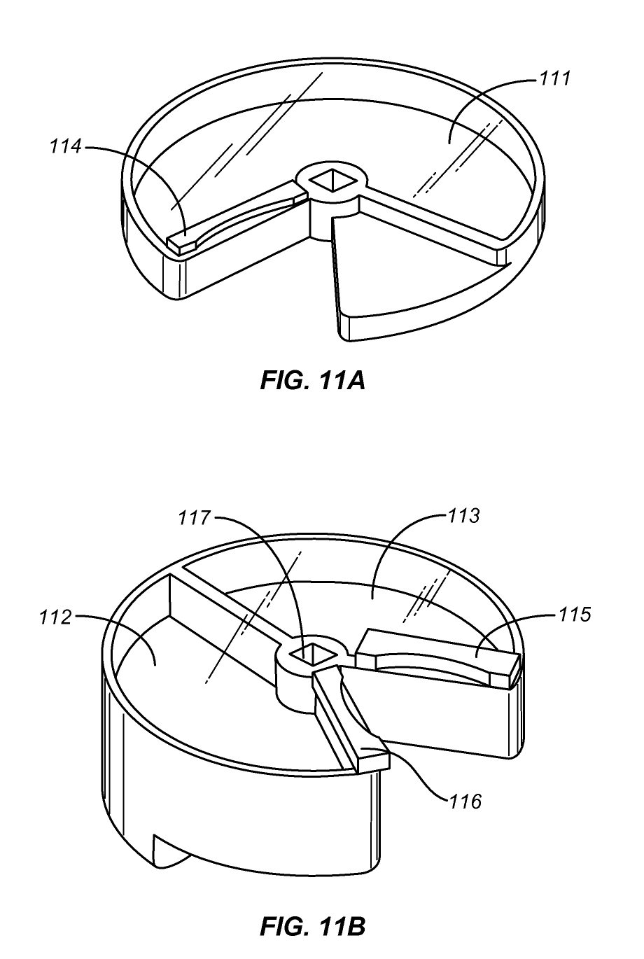

FIG. 10 depicts a sample holder 101 that is insertable in the wide slot 24 in the cover 13. The sample holder has two parallel plates 102, 103 with a small gap between them which serves as a sample cavity holding a liquid sample by capillary force, and a fan-shaped handle 104. The tapering fan shape of the handle 104 mates with the angled baffles 92, 93 (FIG. 9) of the slot 24 in the cover 13 to control the position of the holder inside the assembled assay device. At the base of the handle 104 on either side are shoulders 105, 106 that engage the lower tips 98, 99 of the angled baffles 92, 93 in the interior of the cover 13 (FIG. 9). As the holder snaps into position, these baffle tips engage the shoulders.

An alternative to the two-part pouch 12 of FIGS. 3 and 4 is a pouch of unitary construction shown in FIGS. 11A and 11B. This pouch is a single circular disk with recesses on both sides, the angular width of each recess exceeding 60 degrees. Each recess serves as a reservoir, and one such reservoir 111 opens to one side of the disk, as shown in FIG. 11A, while two additional reservoirs 112, 113 open to the other side of the disk, as shown in FIG. 11B. Each of the three reservoirs is covered by a flexible sheet such as a metallic foil or a plastic film (shown as a transparent film covering the reservoirs for ease of viewing), sealed over the reservoir by an adhesive that extends around the rim of the reservoir. Attached to one radial edge of each sheet is a tab 114, 115, 116 which in this case protrudes upward from the sheet. A bar or hook on the lid extending toward the disk engages the reservoir seal tab(s) on one side of the disk and a tab or hook on the body extending toward the disk engages the reservoir seal tab(s) on the other side of the disk. The disk has a central aperture 117 which has a square, scalloped, or otherwise non-circular inner profile at at least one end, to accommodate a rotary shaft of complementary profile as a means of driving the rotation of the disk. Once the disk rotates to the point where a particular tab or hook on the lid or body engages a reservoir seal tab on the disk, further rotation in the same direction will result in the sheet being peeled back to allow the assay reagent inside the reservoir to flow out.

As noted above, the types of procedures that can be performed using assay devices and/or methods within the scope of this invention are varied and not limited to particular types of assays. Binding assays are among those with which the invention will be particularly useful.

One example is an assay for hemoglobin A1c; others will be readily apparent to those of skill in the art. The methods of detection utilized in the assay can also vary widely. The use of labels that are optically readable or detectable are particularly convenient. Examples are assays using fluorescent labels, turbidometry-based assays, and colorimetry assays. Turbidity-based assays may entail detections of immunoturbidity resulting from the binding of latex to the analyte, and are often useful for analytes such as C-reactive protein (CRP) and microalbumin. Colorimetry assays include those that use color-generating enzymes as labels. Examples of analytes detectable by colorimetry are lipid panels, creatinine, and glucose. Other examples of these and other types of assays will be readily apparent to those of skill in the art.

In the claims appended hereto, the term “a” or “an” is intended to mean “one or more.”

The term “comprise” and variations thereof such as “comprises” and “comprising,” when preceding the recitation of a step or an element, are intended to mean that the addition of further steps or elements is optional and not excluded. All patents, patent applications, and other published reference materials cited in this specification are hereby incorporated herein by reference in their entirety. Any discrepancy between any reference material cited herein or any prior art in general and an explicit teaching of this specification is intended to be resolved in favor of the teaching in this specification. This includes any discrepancy between an art-understood definition of a word or phrase and a definition explicitly provided in this specification of the same word or phrase.

We claim:

1. An assay device for assaying a fluid sample by successive treatments of said sample with a plurality of assay reagents and for allowing measurements to be taken between such treatments, said assay device comprising:
first and second bodies joinable to each other to form a composite body with an axis of rotation;
said first body comprising a plurality of assay reagent reservoirs sealed with openable closures, and said second body comprising means for opening said closures;
said composite body comprising a sample port for receiving said fluid sample and a sample contact chamber in fluid communication with said sample port;
channels arranged within said composite body to selectively communicate each of said plurality of assay reagent reservoirs with said sample contact chamber by rotation of said composite body about said axis of rotation; and
a detection window in said sample contact chamber for allowing access of an optical detection path to said chamber.

2. The assay device of claim 1 wherein said first and second bodies are rotatable relative to each other about said axis of rotation, and said means for opening said closures are actuatable by rotating one of said first and second bodies relative to the other.

3. The assay device of claim 2 wherein said closures are flexible sheets with extensions and said means for opening said closures are implements protruding from said second body that engage said extensions and urge said flexible sheets fully or partially off of said reservoirs upon rotation of one of said first and second bodies relative to the other.

4. The assay device of claim 1 wherein said closures are puncturable films and said means for opening said closures are puncturing members on said second body.

5. The assay device of claim 1 wherein said composite body has an outer periphery and said sample port is at said outer periphery.

6. The assay device of claim 1 further comprising a third body having a cavity for receiving said fluid sample, and wherein said sample port is a recess in said composite body for receiving said third body and, once said third body is so received, for communicating said cavity with said sample contact chamber.

7. The assay device of claim 6 wherein said third body has an outer periphery and said sample port is oriented to cause said third body to enter said composite body at said outer periphery along a direction transverse to said axis of rotation.

8. The assay device of claim 6 wherein said cavity is a gap between two parallel plates.

9. The assay device of claim 1 further comprising an absorbent material within said composite body in fluid communication with said sample contact chamber.

10. The assay device of claim 1 wherein said plurality of assay reagent reservoirs consists of three assay reagent reservoirs.

11. A cartridge for retaining and independently releasing a plurality of liquids, said cartridge comprising a body with at least one substantially planar surface and a plurality of recesses in said at least one surface, each said recess having a mouth opening to said surface and surrounded by a rim, each said recess sealed by a flexible sheet adhered to body along said rim to form a closed cavity for retention of one of said liquids, and each said flexible sheet having a tab extending beyond said rim, said tab oriented such that said flexible sheet is detachable from said recess to open said cavity by pulling said tab.

12. The cartridge of claim 11 wherein said body comprises a pair of oppositely facing, substantially planar surfaces, and at least one of said recesses is in each of said oppositely facing surfaces.

13. The cartridge of claim 11 wherein said body is a disk having a central axis substantially perpendicular to said at least one planar surface, and said body further comprises means for mounting said disk to a rotating member for rotation about said axis.

14. The cartridge of claim 12 wherein said plurality of recesses is three recesses, one of which is in one of said two oppositely facing surfaces and two of which are in the other of said two oppositely facing surfaces.

15. A method for assaying a fluid sample by successive treatments of said sample with a plurality of assay reagents and for taking measurements between such treatments, said method comprising:
(a) placing said sample in a test chamber inside an assay device comprising first and second bodies joined to each other to form a composite body with an axis of rotation, said composite body comprising (i) said test chamber, (ii) a plurality of reservoirs each said reservoir retaining one of said assay reagents and sealed by an openable closure, (iii) means incorporated in said composite body for opening said closures, (iv) internal channels that cause assay reagents to flow individually from said reservoirs to said test chamber by gravity flow upon rotation of said composite body when said closures are open, and (v) a detection window allowing access of an optical detection path to said test chamber;
(b) actuating said means for opening said closures;
(c) rotating said composite body about said axis to cause said treatment fluids to enter said test chamber in succession through said opened closures; and
(d) taking optical measurements of contents of said test chamber through said detection window between successive entries of said assay reagents and assaying said sample from said measurements.

16. The method of claim 15 wherein said first and second bodies are rotatable relative to each other about said axis of rotation, and step (b) comprises rotating one of said first and second bodies relative to the other.

17. The method of claim 16 wherein said closures are flexible sheets with tabs, and said means for opening said closures are members protruding from said second body to engage said tabs and to thereby detach said closures from said reservoirs upon rotation of one of said first and second bodies relative to the other.

18. The method of claim 15 further comprising agitating said contents of said test chamber between entries of said assay reagents therein by oscillating said composite body about said axis of rotation.

19. The method of claim 15 wherein step (a) comprises inserting a sample vessel into said composite body, said fluid sample residing in said sample vessel by capillary force, to cause said fluid sample to enter said test chamber.

20. The method of claim 15 wherein said assay device further comprises an absorbent material retained within said composite body in fluid communication with said test chamber, and step (c) further comprises rotating said composite body sufficiently to cause said assay reagents to pass through said test chamber into said absorbent material.

21. The method of claim 15 wherein one of said assay reagents is a gel suspension that is retained by said test chamber upon entry therein.

22. The method of claim 15 wherein said liquid sample is a blood sample, a first said assay reagent is a suspension of gel material that selectively binds hemoglobin A_{1c} relative to other components of said sample, and a second said assay reagent is a wash buffer.
